(19) United States
(12) Patent Application Publication
(10) Pub. No.: US 2008/0298425 A1
(43) Pub. Date: Dec. 4, 2008

(54) Method and apparatus for melting metals using both alternating current and direct current

(75) Inventor: Edward Scott Jackson, Bonita Springs, FL (US)

Correspondence Address: SAND & SEBOLT, AEGIS TOWER, SUITE 1100, 4940 MUNSON STREET, NW, CANTON, OH, 44718-3615, US

(73) Assignee: TINOMICS, LLC, Fort Myers, FL (US)

(21) Appl. No.: 11/809,560

(22) Filed: Jun. 1, 2007

(51) Int. Cl. H05B 7/18

(52) U.S. Cl. 373/108; 219/121.11

(57) ABSTRACT

A furnace for melting metals includes a crucible, a direct current arc source and an induction coil powered by alternating current. The furnace is particularly useful for melting charges of highly reactive metals such as titanium, zirconium and their alloys without contaminating these charges. The direct current arc source melts generally from the inside out while the water-cooled induction coil serves to cool the crucible and form a skull along the crucible sidewall which protects the crucible from interacting with the molten metal. The induction coil is thus used for cooling as well as heating and stirring the melt, and helps control the thickness of the skull.

### BACKGROUND OF THE INVENTION

1. Technical Field

The present invention relates generally to a furnace and method for melting metals. More particularly, the present invention relates to the melting of metals using a DC power source and an AC power source. Specifically, the invention relates to a furnace and method which utilizes a DC direct arc electrode or plasma torch and an induction coil powered by an AC power source.

2. Background Information

While induction melting of metals is well known in the art, it is most restricted in the lower temperature regimes before the metal or alloy reaches its melting point. Typically, the electromagnetic coupling becomes more efficient once the charge material becomes molten. Thus, any process which aids in the initial low temperature regimes to establish a molten pool of metal helps increase the efficiency of the electromagnetic coupling of the induction field to the metal charge.

Another weakness of the induction melting of metal relates to the fact that the majority of the heating is done at the crucible wall with which the molten metal is in direct contact. This is particularly true in the case of high frequency induction melting. The higher temperatures at the crucible-metal interface leads to a high potential for reactions between the molten metal and the material forming the crucible. The products of these reactions include microscopic “dirt” in the form of oxides (often called low density inclusions), oxygen, carbon, hydrogen and other reaction products. The formation of such oxides occurs because the oxides are very stable while the metals are very unstable. Thus, these compounds are often referred to as oxygen scavengers or “oxygen getters”. For this reason, significant effort and cost has gone into the development of refractory ceramics which lessen the likelihood of metal-ceramic reactions. However, it is very difficult to alleviate all likelihood of such reactions, and with regard to certain metals like titanium, zirconium and their alloys, it is virtually impossible.

In addition, extremely complex and expensive systems have been designed to lessen or alleviate the problem with crucible-metal interface reactions while substituting a copper crucible for a refractory crucible and cooling the copper typically with water in an effort to prevent the melting of the copper due to the high melt temperature of molten metals such as titanium, which is substantially higher than the melting point of copper. Induction melting systems which incorporate this feature are typically referred to as I.S.M. or induction skull melters. This feature is also used with DC ingot and casting systems and is referred to by a number of names, including V.A.R. or vacuum arc remelting, or vacuum arc casting.

Each of these systems has drawbacks. They are expensive to build and operate because the machines have fabricated copper components which are expensive to manufacture. They also require expensive cooling by expensive water systems. Thus, they are not practical to use except in very large size and volume applications.

They can also be dangerous to operate. If the cooling system fails to work properly, the copper shell will melt, allowing the molten charge such as molten titanium to breach the system and combine with the water remaining in the crucible. This typically leads to a steam explosion at the least, and if not arrested, can quickly lead to a much larger and more devastating hydrogen explosion. Unfortunately, there have been some deadly accidents of this sort in the past.

The furnace and the method of the present invention address these and other problems in the art.

### BRIEF SUMMARY OF THE INVENTION

The present invention provides a method comprising the steps of melting with a DC arc source a metal within a melting cavity of a crucible bounded by a crucible wall to form molten metal therewithin; and maintaining a skull along the crucible wall with an induction coil in electrical communication with an AC power source to protect against contact between the molten metal and crucible wall.

The present invention also provides a furnace for melting a metal charge, the furnace comprising a melting crucible defining a melting cavity adapted to receive the metal charge; an electrode adjacent the melting cavity adapted to melt the metal charge; a DC power source in electrical communication with the electrode; an induction coil adjacent the crucible; and an AC power source in electrical communication with the induction coil.

### BRIEF DESCRIPTION OF THE SEVERAL VIEWS OF THE DRAWINGS

FIG. 1 is a diagrammatic elevational view of the first embodiment of the furnace of the present invention showing the crucible and induction coil in section with a solid charge of metal within the crucible.

FIG. 2 is similar to FIG. 1 and shows molten material in the center of the crucible and a skull of solid material along the bottom and side walls of the crucible.

FIG. 3 is similar to FIG. 2 and show a second embodiment of the furnace of the present invention with molten material and a skull within the crucible.

Similar numbers refer to similar parts throughout the drawings.

### DETAILED DESCRIPTION OF THE INVENTION

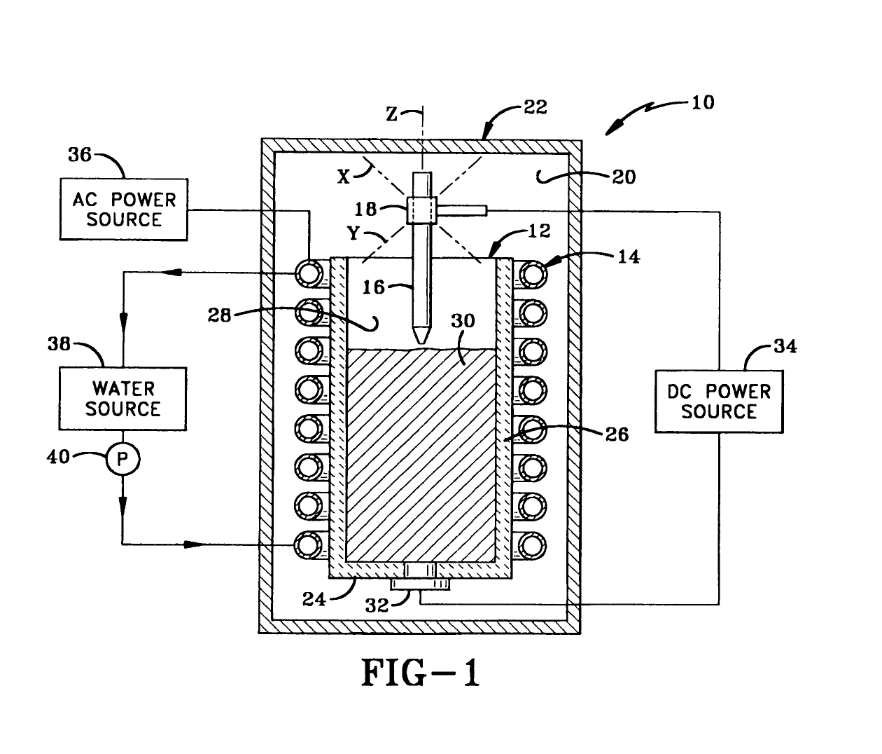

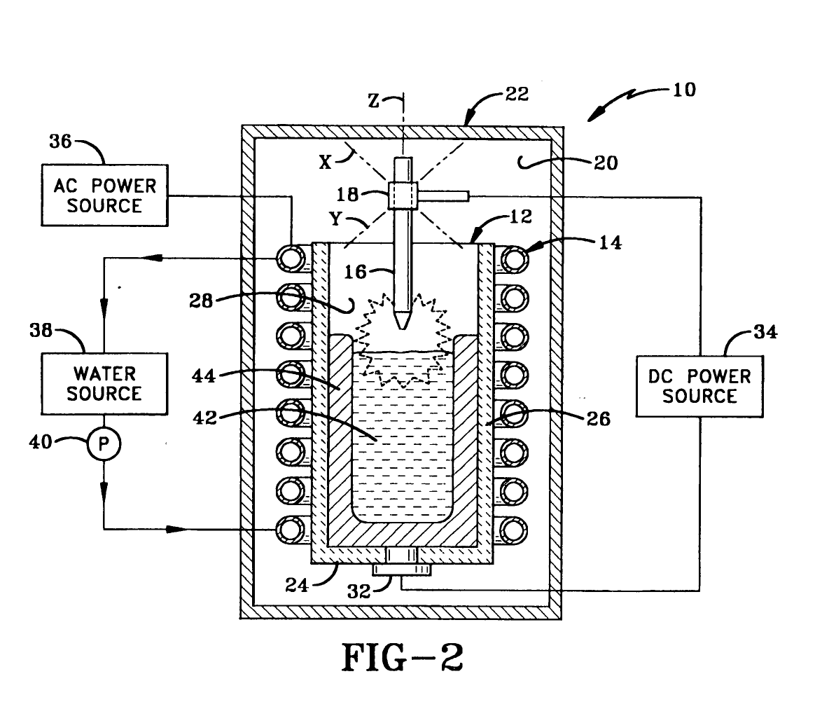

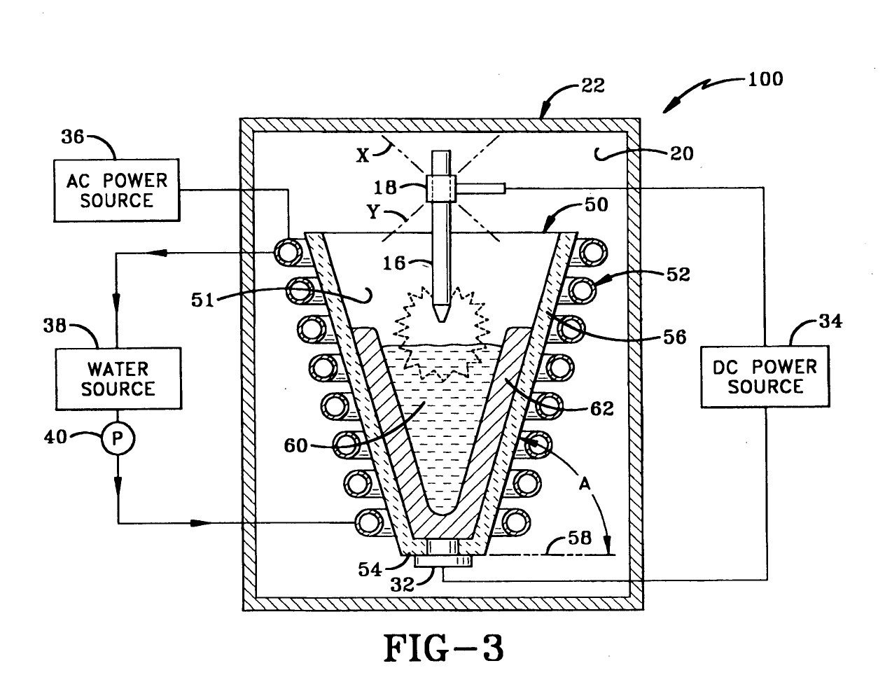

A first embodiment of the furnace of the present invention is indicated generally at 10 in FIGS. 1 and 2; and a second embodiment of the furnace is indicated at 100 in FIG. 3. Furnaces 10 and 100 are configured for melting metals and are particularly useful for melting titanium, zirconium and alloys thereof.

Referring to FIG. 1, furnace 10 includes a crucible 12, a substantially cylindrical induction coil 14 circumscribing crucible 12, a DC powered heat source 16, and a DC power clamp 18 all of which are disposed within a melting chamber 20 defined by a chamber wall 22. Furnace 10 is configured to provide an atmosphere within melting chamber 20 which typically uses an inert gas such as argon or helium and which is typically under a vacuum associated with direct arc electrodes and plasma torches. Heat source 16 includes a consumable electrode or a non-consumable electrode such as a tungsten electrode.

Crucible 12 has a substantially flat bottom wall 24 and a vertical side wall 26 which is typically cylindrical and extends upwardly therefrom to define therewithin a cylindrical melting cavity 28 for receiving a metal charge 30. Crucible 14 is preferably formed of a carbon-graphite material or a ceramic material such as zirconium oxide or yitria oxide. An electrode 32 which may be either an anode or cathode is mounted on bottom wall 24 and extends through a hole formed therein to communicate with melting cavity 28 so that it is in electrical communication with charge 30. Electrode 32 is in electrical communication with a DC power source 34 which involves a power converter for converting AC to DC power. DC power source 34 is likewise in electrical communication with heat source 16 via clamp 18. Heat source 16 may be a direct arc electrode or a plasma torch. Induction coil 14 is in electrical communication with an AC power source 36. AC power source 36 has controls for regulating the amount of power (in kilowatts) and the frequency. Coil 14 is tubular and thus forms a passage so that water from water source 38 may be pumped by pump 40 through the passage to cool coil 14.

The operation of furnace 10 is now described with reference to FIGS. 1 and 2. Furnace 10 may be used to melt various sorts of metals and is particularly useful in the melting of highly reactive metals such as titanium, zirconium and their alloys. Furnace 10 is charged by placing metal charge 30 in melting cavity 28. This may be achieved in a conventional manner at atmosphere or under vacuum via a vacuum lock. While under a suitable vacuum, heat source 16 is powered by DC power source 34. While it has previously been noted that heat source 16 may be a plasma torch, it is described for the present purposes of operation as being a direct arc electrode, either consumable or non-consumable as noted above.

Initially, the power to induction coil 14 from AC power source 36 is in an off condition and water is being circulated via water source 38 and pump 40 through coil 14 in order to actively cool crucible 12 primarily along side wall 26. DC electrode 16 is then powered by DC power source 34 in order to strike an arc to charge 30. The position of electrode 16 is controlled by a three axis positioning system (not shown) which is able to move electrode 16 along axes X, Y and Z and is typically operated via a voltage or current driven feedback loop system. The heat produced by the arc between electrode 16 and charge 30 will melt the metal to create a molten metal bath 42 which has a generally cylindrical shape. The heat produced by the arc of electrode 16 will be generally hottest at the contact with molten bath 42 with the temperatures gradually decreasing radially outward toward side wall 26. In order to prevent molten bath 42 from contacting crucible 12, the cooling provided by the water passing through induction coil 14 cools crucible 12 and in turn cools the metal along the walls of the crucible in order to maintain a solid or semi-solid boundary layer or skull 44 along side wall 26 and bottom wall 24. Thus, the reactive molten metal of bath 42 either does not contact crucible 12 or only does so minimally. Thus, the problem of contamination which would otherwise occur due to the molten metal-crucible interface is eliminated or substantially avoided.

During the melting process, induction coil 14 may be powered by AC power source 36 in order to provide electromagnetic heating and stirring of the molten bath 42. A particular advantage of heating with coil 14 is the ability to maintain a uniformly thick skull 44 along crucible side wall 26. More particularly, skull 44 includes a flat circular bottom wall portion and a cylindrical side wall portion extending vertically upwardly therefrom. In addition, coil 14 may be used to melt the material of skull 44 to allow for its easy removal in the event that the crucible is to be used for another alloy having a different chemistry. Typically, molten material 42 will be poured or otherwise transferred out of crucible 12 and used in the molding of various objects. During pouring, molten material 42 will contact crucible 12 for a relatively brief period so that contamination therebetween is minimal. Once molten material 42 is transferred out of crucible 12, coil 14 is powered to completely melt skull 44 to form additional molten material which may be poured or otherwise transferred from crucible 12 and may be maintained separate from the original molten material 42 to prevent contamination therebetween.

Furnace 100 is now described with reference to FIG. 3. Furnace 100 is similar to furnace 10 except that it includes a crucible 50 and an induction coil 52 each of which tapers upwardly and outwardly to define a frustoconical melting cavity 51. More particularly, crucible 50 includes a horizontal flat circular bottom wall 54 and a substantially conical or frustoconical side wall 56 extending upwardly therefrom. Coil 52 circumscribes side wall 56 and is likewise frustoconical in shape. Side wall 56 forms an angle A relative to horizontal as represented by horizontal line 58 which is somewhere between 10° and less than 90°, in contrast to the vertical side wall 26 of furnace 10. Coil 52 is likewise angled relative to line 58 at angle A unlike the vertical alignment of coil 14 of furnace 10.

Furnace 100 is operated in essentially the same manner as furnace 10 except that the metal charge is melted to form a molten bath 60 which is generally conical in shape and a skull 62 which forms along side wall 56 and bottom wall 54 which is frustoconical and thus has a generally V-shaped cross-section. Thus, the molten bath 60 is wider at its upper surface than at its bottom. Since melting cavity 51 has a diameter which increases from the bottom upward, it provides a greater diameter where the DC arc contacts the surface of molten bath 60 where the greatest amount of heat is produced. This configuration helps to insure that skull 62 has a substantially uniform thickness and also adds to the volume of the crucible without creating hot zones in the crucible. Skull 62 has a conical or frustoconical shape.

In addition to the various advantages noted above, furnaces 10 and 100 may be used in a more standard fashion. For instance, if the metal or metal alloy to be melted is relatively non-reactive with the material of the crucible, such as a copper or stainless steel charge, it may be preferred to use the furnace as a traditional induction furnace. In addition, if it is desired to provide vigorous stirring of the molten metal in order to homogenize the bath, the use of the AC induction coil may also be preferred.

On the other hand, the combined use of the DC arc source and the AC induction coil may be preferred in order to rapidly melt a given charge. For instance, if an alloy contains constituents with extremely low vapor pressure points, it may be desirable to reduce the residence time of the constituents in the molten bath in order to reduce the chances of vaporizing or oxidizing the constituents and altering the bath chemistry. Thus, furnaces 10 and 100 provide new advantages as well as versatility.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described.

1. A method comprising the steps of:
melting with a DC arc source a metal within a melting cavity of a crucible bounded by a crucible wall to form molten metal therewithin; and
maintaining a skull along the crucible wall with an induction coil in electrical communication with an AC power source to protect against contact between the molten metal and crucible wall.

2. The method of claim 1 wherein the step of melting comprises the step of melting with one of a DC direct arc electrode and a DC plasma torch a metal within a melting cavity of a crucible bounded by a crucible wall to form molten metal therewithin.

3. The method of claim 1 wherein the step of maintaining comprises the step of powering the induction coil with the AC power source.

4. The method of claim 3 wherein the step of maintaining comprises the step of circulating water through the induction coil when the induction coil is not being powered by the AC power source.

5. The method of claim 1 wherein the step of maintaining comprises the step of moving water through the induction coil to cool the crucible wall.

6. The method of claim 1 wherein the step of maintaining comprises the step of maintaining a skull of substantially uniform thickness along the crucible wall with an induction coil in electrical communication with an AC power source to protect against contact between the molten metal and crucible wall.

7. The method of claim 6 wherein the step of maintaining comprises the step of maintaining a substantially cylindrical skull of substantially uniform thickness along the crucible wall with an induction coil in electrical communication with an AC power source to protect against contact between the molten metal and crucible wall.

8. The method of claim 6 wherein the step of maintaining comprises the step of maintaining a skull which has a substantially uniform horizontal thickness and which extends vertically along a vertical crucible wall with an induction coil in electrical communication with an AC power source to protect against contact between the molten metal and crucible wall.

9. The method of claim 6 wherein the step of maintaining comprises the step of maintaining a conical or frustoconical skull of substantially uniform thickness along the crucible wall with an induction coil in electrical communication with an AC power source to protect against contact between the molten metal and crucible wall.

10. The method of claim 9 wherein the step of maintaining comprises the step of maintaining the conical or frustoconical skull of substantially uniform thickness so that it forms an angle with respect to horizontal which is in the range of 10 to 80 degrees.

11. The method of claim 1 wherein the step of melting comprises the step of melting within a melting cavity bounded by a crucible sidewall which tapers upwardly and outwardly; and the step of maintaining comprises the step of maintaining a skull along the tapered crucible sidewall with an induction coil which is in electrical communication with an AC power source and tapers upwardly and outwardly around the crucible wall in a mating fashion.

12. The method of claim 11 wherein the step of melting comprises the step of melting within a melting cavity bounded by one of a conical and a frustoconical crucible sidewall which tapers upwardly and outwardly; and the step of maintaining comprises the step of maintaining a skull along the crucible sidewall with a frustoconical induction coil in electrical communication with an AC power source.

13. The method of claim 12 wherein the step of melting comprises the step of melting within a melting cavity bounded by one of a conical and a frustoconical crucible sidewall which tapers upwardly and outwardly to form an angle with respect to horizontal which is in the range of 10 to 80 degrees; and the step of maintaining comprises the step of maintaining a skull along the crucible sidewall with a frustoconical induction coil which is in electrical communication with an AC power source and forms an angle with respect to horizontal which is in the range of 10 to 80 degrees.

14. The method of claim 11 wherein the step of melting comprises the step of melting within a melting cavity bounded by a crucible sidewall which tapers upwardly and outwardly to form an angle with respect to horizontal which is in the range of 10 to 80 degrees; and the step of maintaining comprises the step of maintaining a skull along the tapered crucible sidewall with an induction coil which is in electrical communication with an AC power source and tapers upwardly and outwardly to form an angle with respect to horizontal which is in the range of 10 to 80 degrees.

15. The method of claim 1 wherein the step of melting comprises the step of melting with a DC arc source a metal within a melting cavity of a crucible formed of a non-metallic material.

16. The method of claim 1 wherein the step of melting comprises the step of melting with a DC arc source a metal within a melting cavity of an electrically non-conductive crucible.

17. The method of claim 1 wherein the step of melting comprises the step of melting with a DC arc source a metal within a melting cavity of a crucible formed of one of a carbon-graphite material and a ceramic material.

18. The method of claim 1 further comprising the step of transferring the molten material out of the crucible.

19. The method of claim 18 further comprising the step of melting the skull entirely with the induction coil to form molten skull material; and transferring the molten skull material out of the crucible.

20. The method of claim 1 wherein the step of melting comprises the step of melting at least one of titanium and zirconium.

21. The method of claim 1 wherein the step of melting comprises the step of powering the DC arc source with a DC power source; and the step of maintaining comprises the step of powering the induction coil with the AC power source.

22. The method of claim 21 wherein the step of powering the induction coil comprises the step of powering the induction coil with the AC power source to help control thickness of the skull.

23. The method of claim 21 wherein the step of powering the induction coil comprises the step of powering the induction coil with the AC power source to stir the molten material.

24. The method of claim 21 wherein the step of powering the induction coil comprises the step of powering the induction coil with the AC power source to remove the skull entirely from the crucible wall.

25. A furnace for melting a metal charge, the furnace comprising:
a melting crucible defining a melting cavity adapted to receive the metal charge;
an electrode adjacent the melting cavity adapted to melt the metal charge;
a DC power source in electrical communication with the electrode;
an induction coil adjacent the crucible; and
an AC power source in electrical communication with the induction coil.
